(19) United States
(12) Patent Application Publication
(10) Pub. No.: US 2022/0100006 A1
(43) Pub. Date: Mar. 31, 2022

(54) ELECTRONIC EYEGLASSES

(71) Applicant: LUXOTTICA S.R.L., Agordo (IT)

(72) Inventors: Fabio BORSOI, Vittorio Veneto (IT); Valerio OLIANA, Tione di Trento (IT); Moreno DAL PONT, Sedico (IT)

(21) Appl. No.: 17/312,266

(22) PCT Filed: Dec. 14, 2018
(86) PCT No.: PCT/IB2018/060103

§ 371 Date: Jun. 9, 2021

(51) Int. Cl. G02C 11/00; G02C 5/14; G02C 5/22

(52) U.S. Cl. CPC G02C 11/10; G02C 5/22; G02C 5/14

(57) ABSTRACT

Electronic eyeglasses include a front body adapted to retain at least one lens and two lateral ends to each of which a temple for fixing the eyeglasses to the head of the user is connected. The eyeglasses includes one or more electronic components including at least one electronic acquisition component. The electronic components are accommodated exclusively inside at least one of the two temples and in that the at least one temple that accommodates the electronic components has at least one optical element which provides optical communication between at least one electronic acquisition component and the outside environment.

### TECHNICAL FIELD

The present disclosure relates to electronic eyeglasses.

More particularly, the disclosure relates to electronic eyeglasses particularly but not exclusively useful and practical in the field of fashion.

### BACKGROUND

As is known, eyeglasses are devices which primarily perform the function of protecting the eyes of the user from the rays of the sun and/or of correcting eyesight disorders by means of appropriate lenses.

This main function is now accompanied by the function of aesthetic and design accessory that follows the trends of the fashion industry, which today is no less important from the commercial standpoint.

Eyeglasses are normally constituted by a front body which accommodates the lenses and by two temples which allow the user to wear them, placing them on the temples of the head so that they rest on the ears.

The front body is the element that mainly characterizes the aesthetic appearance of the eyeglasses and can assume various shapes and dimensions. In particular, in the fashion industry, where the design element is predominant, the range varies from eyeglasses with very large and conspicuous front bodies, sometimes having unusual shapes, to eyeglasses in which the front body is very simple and thin.

Particular eyeglasses known as electronic eyeglasses have recently been developed, i.e., eyeglasses which comprise electronic components and which associate with the main function of the eyeglasses additional functions which are commonly performed by other devices, such as for example playing music, answering the telephone, taking videos or photographs, acquiring physiological parameters, detecting environmental parameters, etc.

The electronic components that are present in electronic eyeglasses can be for example microchips, sensors, displays, charge generators, batteries, connectors, etc.

According to the background art, the electronic components are normally distributed in all the parts of the eyeglasses, i.e., both inside the front body and inside the temples.

In general, in electronic eyeglasses of the known type, at least part of the electronics is accommodated inside the front body.

In particular, in electronic eyeglasses of the known type provided with electronic components aimed at acquiring images, or at detecting the light that is incident on the eyes, these components are always placed on the front body, since they must acquire light or images that arrive from the viewing field of the user.

In these eyeglasses, therefore, the dimensions, design and aesthetic appearance are heavily influenced by the presence of the electronic components. In particular, the front body must have dimensions and a shape suitable to allow the correct operation of the electronic part.

These limitations make electronic eyeglasses of the known type scarcely suitable for use in the fashion industry, where, as already noted, there is a strong need to have eyeglasses having the most disparate shapes and dimensions.

Furthermore, again in the fashion sector, the same manufacturer commonly has to modify the design of his products very rapidly and this entails, for electronic eyeglasses of the known type, the need to redesign the electronic part every time there is a design change and for every model of eyeglasses, with the obvious disadvantages in terms of costs and times.

Another drawback of electronic eyeglasses of the known type resides in that the presence of the electronic components makes the eyeglasses scarcely balanced, causing imbalances to the full detriment of wearing comfort. In particular, eyeglasses of the known type often have a weight that imbalanced toward the front body or toward a single temple.

### SUMMARY

The aim of the present disclosure is to overcome the limitations of the background art described above, devising electronic eyeglasses that can be adapted for use in the field of fashion, offering great flexibility in design as regards shapes and dimensions.

Within the scope of this aim, the present disclosure provides electronic eyeglasses in which the aesthetic design can be modified without having to redesign the electronic part.

The disclosure also provides electronic eyeglasses which, despite being provided with electronic components aimed at acquiring images, or at detecting incident light, can have a light front body having any shape.

The disclosure further provides electronic eyeglasses that are balanced and comfortable to wear.

The disclosure also provides electronic eyeglasses that are easy to provide and economically compete if compared with the background art.

This aim, these advantages and others which will become better apparent hereinafter are achieved by providing electronic eyeglasses comprising:
a front body adapted to retain at least one lens and comprising two lateral ends to each of which a temple for fixing the eyeglasses to the head of the user is connected; and
one or more electronic components, including at least one electronic acquisition component;

said electronic eyeglasses being configurable at least in an open condition that allows the eyeglasses to be worn by the user and in which the temples are arranged substantially parallel to each other and at right angles to the front body, characterized in that said electronic components are accommodated exclusively inside at least one of said two temples and in that said at least one temple that accommodates the electronic components comprises at least one optical element which provides optical communication between at least one electronic acquisition component and the outside environment.

### BRIEF DESCRIPTION OF THE DRAWINGS

Further characteristics and advantages will become better apparent from the description of four preferred but not exclusive embodiments of a pair of electronic eyeglasses, illustrated by way of nonlimiting example with the aid of the accompanying drawings, wherein:

FIG. 1 is a perspective view of a first possible embodiment of the electronic eyeglasses according to the disclosure, with the temples detached from the front body;

FIG. 2 is a perspective view of the same first embodiment of the electronic eyeglasses of FIG. 1, with the temples connected to the front body;

FIG. 3 is a sectional top view of the portion of the temple that accommodates the electronic components of the electronic eyeglasses of FIG. 2;

FIG. 4 is a perspective view of a second possible embodiment of the electronic eyeglasses according to the disclosure, with the temples detached from the front body;

FIG. 5 is a perspective view of said second embodiment of the electronic eyeglasses of FIG. 4, with the temples connected to the front body;

FIG. 6 is a perspective view of a third possible embodiment of the electronic eyeglasses according to the disclosure, with the temples detached from the front body;

FIG. 7 is a perspective view of the same third embodiment of the electronic eyeglasses according to the disclosure of FIG. 6, with the temples connected to the front body;

FIG. 8 is a sectional top view of the portion of the temple that accommodates the electronic components of the electronic eyeglasses of FIG. 7;

FIG. 9 is a perspective view of a fourth possible embodiment of the electronic eyeglasses according to the disclosure, with the temples detached from the front body; and

FIG. 10 is a perspective view of the same fourth embodiment of the electronic eyeglasses of FIG. 9, with the temples connected to the front body.

### DETAILED DESCRIPTION OF THE DRAWINGS

With reference to the figures, the electronic eyeglasses, designated generally by the reference numerals 10a, 10b, 10c and 10d, depending on the embodiment, comprise a front body 20 which is adapted to retain at least one lens 30 and comprises two lateral ends 21a, 21b, to each of which a temple 40, 40e is connected for the fixing of the eyeglasses 10a, 10b, 10c, 10d to the head of the user.

The front body 20, as will become better apparent hereinafter, can have any shape and dimensions, depending on the requirements and the design choices.

The lenses 30 are preferably two, one for each eye, but it is also possible to provide eyeglasses according to the disclosure which are characterized by a single contoured lens that covers both eyes.

Furthermore, the lenses 30 can be of any type known in the art, both protective lenses and corrective lenses.

In the illustrated examples, the temples 40, 40e are of the type commonly used in commercially available eyeglasses, i.e., characterized by a proximal portion, adjacent to the front body, that is substantially rectilinear and a distal portion which is slightly arc-like in order to be rested comfortably on the ears. However, according to the disclosure, it is also possible to use temples having a more unusual shape.

The temples are connected to the two lateral ends 21a, 21b of the front body 20 by means of one of the known methods, such as for example the use of hinges which allow the temples 40, 40e to rotate through 90° and pass from an open position to a folded position.

The electronic eyeglasses therefore can be configured at least in an open condition, which allows the eyeglasses to be worn by the user and in which the temples 40, 40e are arranged substantially parallel to each other and perpendicular to the front body 20, and preferably also in a closed condition, in which the temples 40, 40e are folded and substantially parallel to the front body 20.

According to an optional and advantageous characteristic, the temples 40, 40e are connected to the front body 20 so that they can be easily connected and disconnected, so as to allow the user easy replacement of the temples 40, 40e and/or of the front body 20.

The electronic eyeglasses furthermore comprise one or more electronic components 51, 52, which include at least one electronic acquisition component 52.

The expression “electronic acquisition component” is understood here as any device capable of detecting, acquiring and/or measuring data that arrives from the outside environment, such as for example microcameras, still cameras, video cameras, optical sensors (for example for visible light and/or UV light, and/or blue light and/or infrared light) and sensors for measurement in general, such as for example proximity sensors, distance sensors and environmental sensors (temperature, relative humidity, . . . ).

The electronic eyeglasses according to the disclosure furthermore comprise, although they are not shown in the figures, all the other electronic components which in the background art are necessary at least for the operation of the electronic acquisition component 52, such as for example one or more batteries 51 or charge generators, microchips or means for the electrical connection of the electronic components 51, 52.

Furthermore, the electronic eyeglasses according to the disclosure can optionally comprise also other electronic components for the implementation of additional functions, such as for example connectors, data storage means, displays, transmission means, etc.

According to the disclosure, the front body 20 is free from electronic components, since the electronic components 51, 52 are accommodated exclusively inside at least one temple 40e of the two temples.

In practice, according to the disclosure, all the electronic components 51, 52 are arranged inside a temple 40e or, as an alternative, inside both temples 40e.

In this manner, the front body 20 is completely free from the constructive constraints dictated by the presence of the electronic components 51, 52 and can thus be provided in the most disparate shapes and dimensions. Furthermore, the absence of electronic components 51, 52 in the front body 20 has the advantage of avoiding the imbalance of the eyeglasses 10a, 10b, 10c, 10d toward the front part.

Preferably, all the electronic components 51, 52 are arranged in the proximal portion of the temple 40e that accommodates them.

The electronic components can be arranged within one or more cavities appropriately provided in the accommodating temple 40e or directly integrated in said accommodating temple 40e, depending on the constructive choices.

Furthermore, according to the disclosure, the at least one at temple 40e that accommodates the electronic components 51, 52 comprises at least one optical element 60, which establishes an optical communication between at least one electronic acquisition component 52 and the outside environment.

In practice, in the proximal part of each temple 40e that accommodates the electronic components 51, 52 there is at least one optical element 60, which allows the light radiation L that arrives from the outside environment to reach the electronic acquisition component 52.

In the preferred and illustrated embodiments, the optical elements 60 are defined on a front face 41 of each one of the temples 40e that accommodate the electronic components 51, 52.

The expression “front face” 41 is meant the face that defines the proximal end, i.e., the end closest to the front body 20, of the temple 40, 40e.

Said front faces 41 of the temples 40, 40e, as shown in the figures, are adjacent to the front body 20.

Furthermore, again in the preferred and illustrated embodiments, the axis of each optical element 60 is substantially parallel to the longitudinal axis of the temple 40e in which said optical element 60 is comprised and, when the eyeglasses are in the open condition and being worn, is oriented toward the viewing field of the user who is wearing the eyeglasses.

In practice, when the electronic eyeglasses are worn, the axes of the optical elements 60 are oriented substantially in the same direction as the axis of the gaze of the user.

Advantageously, said optical elements 60 are axial holes at the front face 41 of the temples 40e.

Optionally, each axial hole can be constituted by a shielding element that is at least partly transparent to at least one portion of the electromagnetic spectrum, such as for example a glass, a plastic wall, a lens or an optical filter.

In first and second possible embodiments 10a, 10b, shown in FIGS. 1, 2, 3, 4 and 5, when the eyeglasses are configured in the open condition, the front faces 41 of the temples 40, 40e are arranged to the rear of the front body 20, each proximate to one of the two lateral ends 21a, 21b.

Also in these first two embodiments, in the front body 20 there is advantageously at least one optical element 22 proximate to at least one lateral end 21a, 21b and at each optical element 60, so as to allow optical communication between at least one electronic acquisition component 52 and the outside environment by means of said optical element 22.

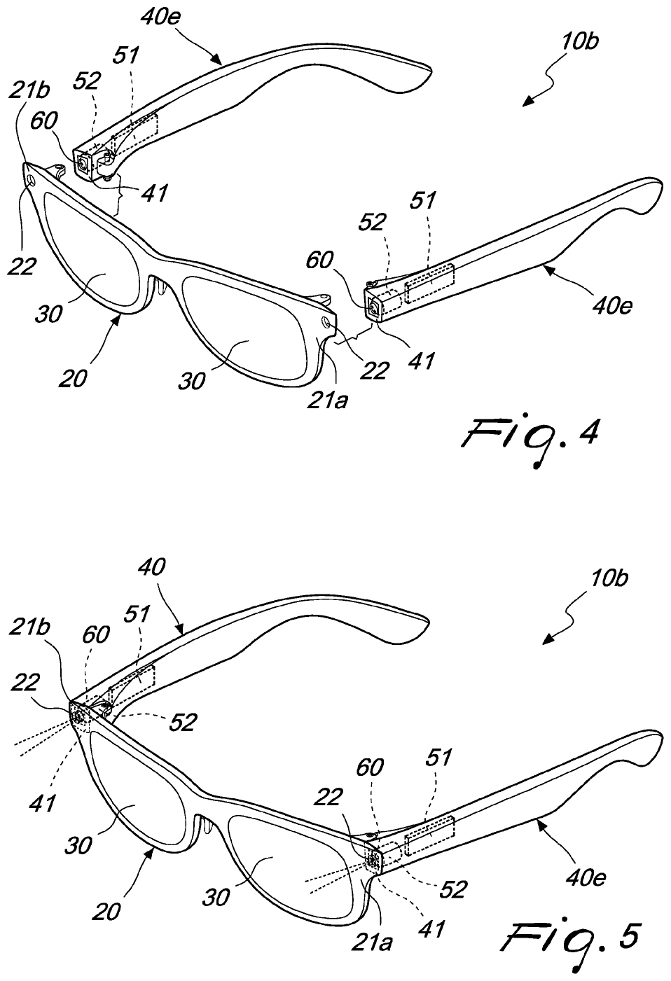

In practice, when the eyeglasses are in the open condition, as clearly visible in FIG. 3, the optical element 60 and the respective optical element match up, forming a single passage which provides optical communication between the electronic acquisition component 52 and the outside environment.

The advantage of this solution resides in that the electronic acquisition component 52 “looks” toward the viewing field of the user, as if it were mounted on the front body 20, despite being accommodated inside on temple 40e of the temples.

Optionally, each one of the optical elements 22 can be closed by means of a shielding element 71 that is at least partially transparent to at least one portion of the electromagnetic spectrum, such as for example a glass, a plastic wall or a lens or an optical filter.

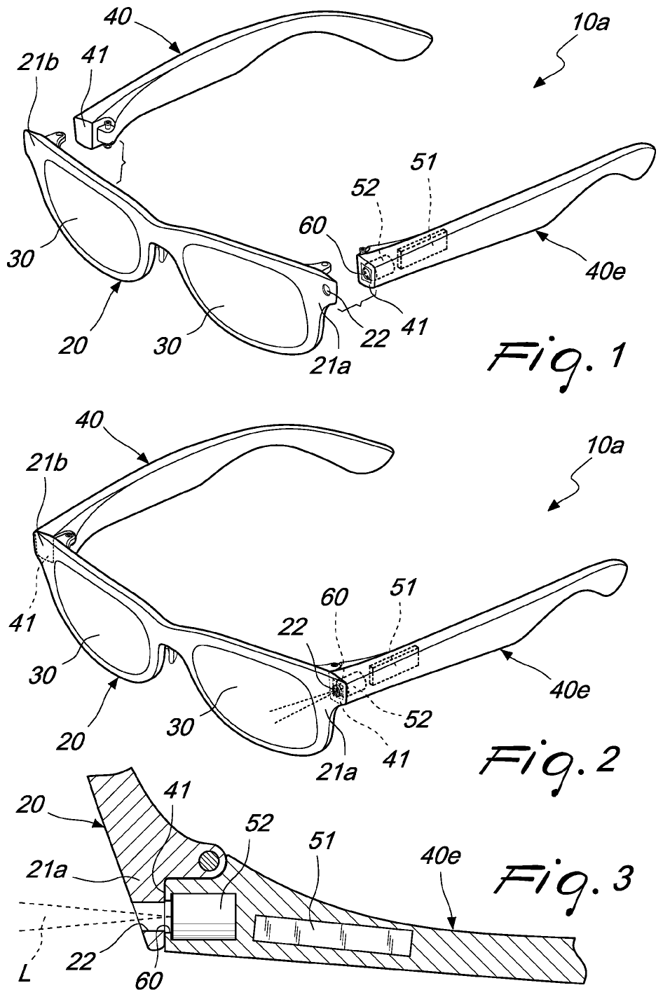

In the first embodiment 10a, shown in FIGS. 1 and 2, the temple 40e that accommodates the electronic components 51, 52 is a single one, so that the electronic eyeglasses 10a comprise a temple 40e which accommodates the electronic components 51, 52 and a temple 40 which does not accommodate electronic components.

Advantageously, the temple 40e that accommodates the electronic components 51, 52 and the temple 40 that does not accommodate electronic components substantially have the same weight and the same volume.

This result can be achieved, for example, by inserting in the temple asymmetric decorative elements such as for example logos and/or decorations, or by using materials having a different density, such as for example polymers with different fillers or balancing elements specifically designed to compensate any imbalances.

As an alternative, if the electronic components weigh less than the plastic material that surrounds them, it may be necessary to create appropriate voids.

In this manner, the electronic eyeglasses 10a are free from imbalances that can influence correct fit.

In this first embodiment 10a, the electronic acquisition component is preferably a means for the acquisition of images and/or videos, such as for example a video camera or a still camera, or an optical sensor for detecting UV light and/or visible light and/or another predetermined portion of the electromagnetic spectrum.

In the second possible embodiment, shown in FIGS. 4 and 5, the temples 40e that accommodate the electronic components 51, 52 are two, each comprising an electronic acquisition component 52 and an optical element 60 which matches up with an optical element 22 provided on the front body 20.

In a manner similar to the previously described embodiment, the two temples 40e that accommodate the electronic components have substantially the same weight and the same volume.

In this second embodiment, the two electronic acquisition components 52 are preferably a means for the acquisition of images and/or video, such as for example a video camera or a still camera, or an optical sensor for detecting UV light and/or visible light and/or another predetermined portion of the electromagnetic spectrum.

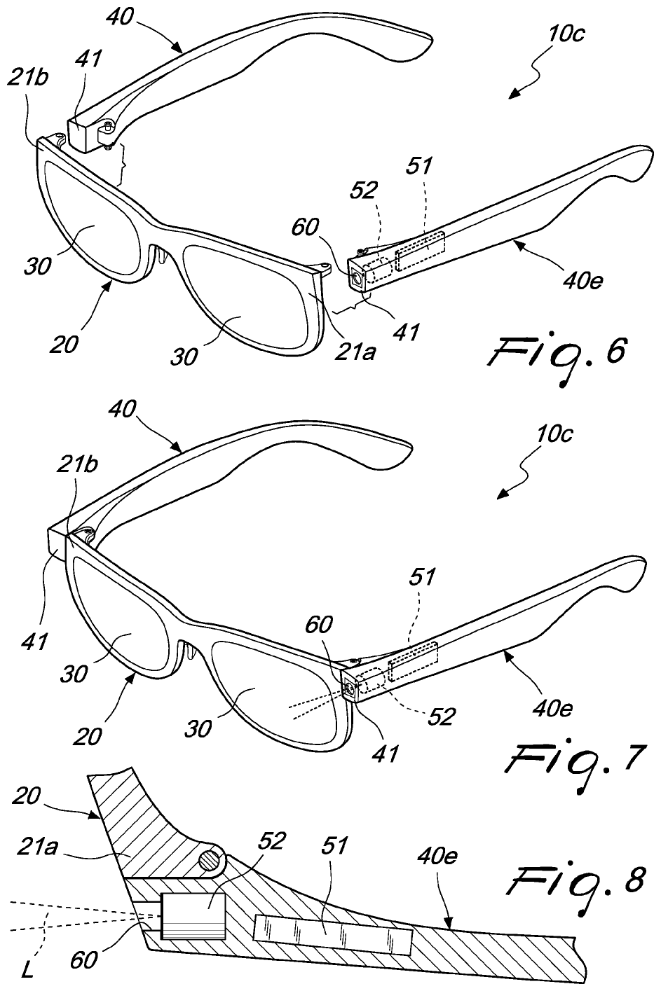

FIGS. 6, 7, 8, 9 and 10 show a third and a fourth possible embodiment 10c, 10d. In these further embodiments, differently from the ones described previously, when the eyeglasses 10c, 10d are in the open condition each one of the front faces 41 of the temples 40, 40e is laterally adjacent to a lateral end 21a, 21b of the front body 20.

In practice, in these last embodiments, the temples 40, 40e are advantageously mounted so that they are adjacent to the front body 20 laterally and not the to the rear, so that the front faces 41 are not covered by any element.

In this manner, as clearly visible in FIG. 8, the electronic acquisition component 52 communicates with the outside environment directly by means of the optical element 60.

The advantage of this solution resides in that the electronic acquisition component 52 “looks” toward the viewing field of the user, as if it were mounted on the front body, despite being accommodated inside one of the temples 40e and without there being openings in the front body 20.

In the third embodiment 10c, shown in FIGS. 6 and 7, the temple 40e that accommodates the electronic components 51, 52 is a single one, so that the electronic eyeglasses 10c comprises a temple 40e that accommodates the electronic components 51, 52 and a temple 40 that does not accommodate electronic components.

Also in this third embodiment 10c, the electronic acquisition component is preferably a means for the acquisition of images and/or video, such as for example a video camera or a still camera, or an optical sensor for detecting UV light and/or visible light and/or another predetermined portion of the electromagnetic spectrum.

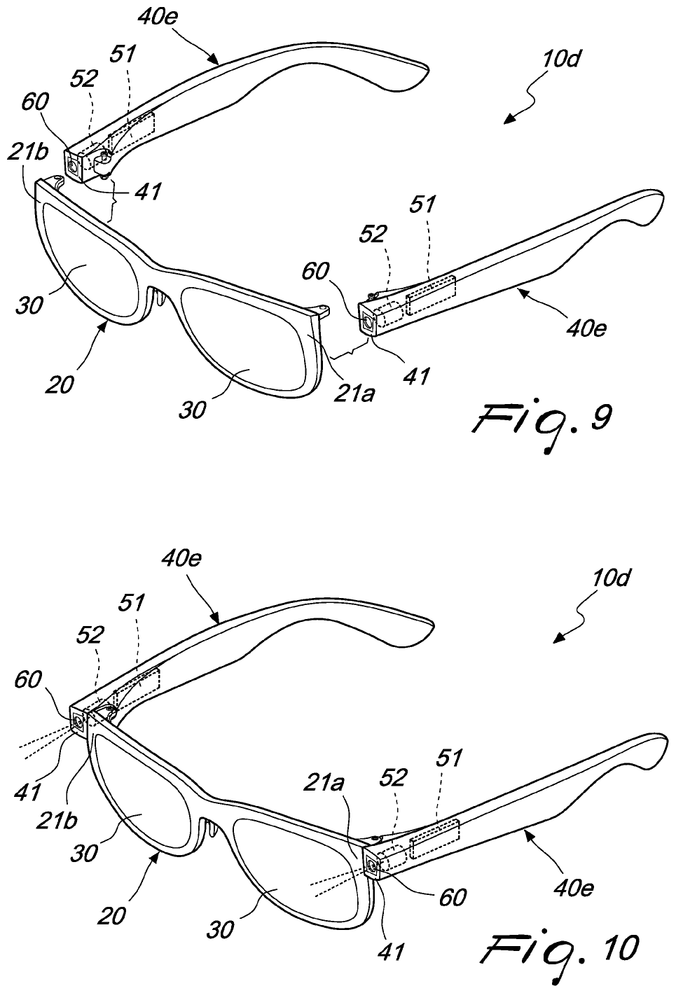

In the fourth possible embodiment 10d, shown in FIGS. 9 and 10, instead, the temples 40e that accommodate the electronic components are two, each comprising at least one electronic acquisition component 52 and at least one optical element 60.

In this fourth embodiment 10d, the two electronic acquisition components 52 are a means for the acquisition of images and/or video, such as for example a video camera or a still camera, or an optical sensor for detecting UV light and/or visible light and/or another predetermined portion of the electromagnetic spectrum.

In these last two described embodiments as well, the two temples 40, 40e have substantially the same weight and the same volume.

The operation of the electronic eyeglasses is clear and evident from what has been described.

In practice it has been found that the electronic eyeglasses according to the present disclosure achieve the intended aim and objects, since they are suitable for use in the field of fashion, offering broad flexibility in design as regards shapes and dimensions.

Another advantage of the electronic eyeglasses according to the disclosure resides in that they allow to change the aesthetic design without having to redesign the electronic part.

A further advantage of the electronic eyeglasses according to the disclosure resides in that although they are provided with electronic components aimed at image acquisition, or at the detection of the light that is incident on the eyes, they can have a light front body that has any shape.

Another advantage of the electronic eyeglasses according to the disclosure resides in that they are balanced and comfortable to wear.

A further advantage of the electronic eyeglasses according to the disclosure resides in that they are easy to provide and economically competitive if compared with the background art.

The electronic eyeglasses thus conceived are susceptible of numerous modifications and variations, all of which are within the scope of the accompanying claims.

All the details may furthermore be replaced with other technically equivalent elements.

In practice, the materials used, so long as they are compatible with the specific use, as well as the contingent shapes and dimensions, may be any according to the requirements and the state of the art.

To conclude, the scope of the protection of the claims must not be limited by the illustrations or preferred embodiments shown in the description by way of example, but rather the claims must comprise all the characteristics of patentable novelty that reside in the present disclosure, including all the characteristics that would be treated as equivalents by the person skilled in the art.

1-16. (canceled)

17. Electronic eyeglasses comprising:
a front body adapted to retain at least one lens and comprising two lateral ends to each of which a temple for fixing the eyeglasses to the head of a user is connected; and
one or more electronic components including at least one electronic acquisition component;
said electronic eyeglasses being configurable at least in an open condition that allows the eyeglasses to be worn by the user and in which the temples are arranged substantially parallel to each other and at right angles to the front body, wherein said electronic components are accommodated exclusively inside at least one of said two temples and wherein said at least one temple that accommodates the electronic components comprises at least one optical element which provides optical communication between at least one electronic acquisition component and the outside environment.

18. The electronic eyeglasses according to claim 17, wherein said at least one optical element is provided on a front face of said at least one temple which accommodates the electronic components, said front face of the temple being adjacent to the front body, and wherein an axis of said at least one optical element, when the electronic eyeglasses are in the open condition and are being worn, is oriented toward the viewing field of the user wearing the eyeglasses.

19. The electronic eyeglasses according to claim 18, wherein in the open condition each one of said front faces of the temples is laterally adjacent to a lateral end of the front body.

20. The electronic eyeglasses according to claim 18, wherein in the open condition said front faces of the temples are arranged at the rear of the front body, each one proximate to one of the two lateral ends; in the front body there being at least one optical element proximate to at least one lateral end and at each optical element, so as to allow optical communication between said at least one electronic acquisition component and the outside environment by said at least one optical element.

21. The electronic eyeglasses according to claim 20, wherein said at least one optical element is constituted by a shielding element that is at least partially transparent to at least one portion of the electromagnetic spectrum.

22. The electronic eyeglasses according to claim 20, wherein said at least one optical element is constituted by a hole for the passage of light.

23. The electronic eyeglasses according to claim 17, wherein said electronic components are accommodated in a single one of said temples, said temple that accommodates the electronic components and the other temple that does not accommodate the electronic components having substantially the same weight and the same volume.

24. The electronic eyeglasses according claim 17, wherein said electronic components are accommodated in both temples; said two temples that accommodate the electronic components having substantially a same weight and a same volume.

25. The electronic eyeglasses according to claim 17, wherein at least one of said electronic acquisition components is configured for the acquisition of images and/or video.

26. The electronic eyeglasses according to claim 17, wherein at least one of said electronic acquisition components is an optical sensor for detecting UV light and/or visible light and/or another predetermined portion of the electromagnetic spectrum.

27. The electronic eyeglasses according to claim 17, wherein said at least one optical element is constituted by a shielding element that is at least partially transparent to at least one portion of the electromagnetic spectrum.

28. The electronic eyeglasses according to claim 17, wherein said at least one optical element is constituted by a hole for the passage of light.

29. A temple for eyeglasses comprising: electronic components including at least one electronic acquisition component and are accommodated exclusively inside said temple, and wherein said temple that accommodates the electronic components comprises at least one optical element that provides optical communication between said at least one electronic acquisition component and the outside environment.

30. The temple for eyeglasses according to claim 29, wherein said at least one optical element is provided on a front face of said at least one temple that accommodates the electronic components, said front face of the temple being adapted to be adjacent to a front body of the eyeglasses.

31. The temple for eyeglasses according to claim 29, wherein said at least one optical element is constituted by a shielding element that is at least partly transparent to at least one portion of the electromagnetic spectrum.

32. The temple for eyeglasses according to claim 29, wherein at least one of said electronic acquisition components is configured for the acquisition of images and/or video.
